(19) United States
(12) Patent Application Publication
(10) Pub. No.: US 2024/0035488 A1
(43) Pub. Date: Feb. 1, 2024

(54) CENTRIFUGAL INCOMPRESSIBLE FLUID PUMP

(71) Applicant: Barrington Pumps Pty Ltd, Somerville, VIC (AU)

(72) Inventor: Garth Barrington Davey, Somerville, VIC (AU)

(21) Appl. No.: 18/547,201

(22) PCT Filed: Feb. 22, 2022
(86) PCT No.: PCT/AU2022/050128

§ 371 Date: Aug. 21, 2023

(30) Foreign Application Priority Data
Feb. 22, 2021 (AU) 2021900458

(51) Int. Cl. F04D 29/42; F04D 1/00; F04D 27/02; F04D 29/22

(52) U.S. Cl. CPC F04D 29/426; F04D 1/00; F04D 27/0207; F04D 29/22

(57) ABSTRACT

A centrifugal incompressible fluid pump comprising a casing with a pump inlet and a pump outlet, the casing housing an impeller powered to rotate by a drive system and having a fluid passage between an impeller fluid inlet and a fluid outlet located radially of the fluid inlet; and a recoveiy by-pass turbine system comprising a recovery by-pass turbine mounted to rotate with the impeller, wherein the recoveiy turbine system diverts a portion of fluid that has exited the impeller fluid outlet back into the impeller fluid intake, wherein the remaining portion of fluid exits the pump through the pump outlet.

### FIELD OF INVENTION

The present invention relates to a centrifugal fluid pump suitable for use with incompressible fluids and suitable for use in a single stage, but not necessarily restricted to a single stage. Applications for the pump include but are not limited to marine propulsion and hydraulic pumps.

### BACKGROUND

Incompressible fluid pumps fall into the category of turbomachines that add energy to fluid. Centrifugal pumps are a form of rotodynamic pump comprising an impeller rotating within a casing where fluid enters axially through the eye (central part) of the casing, is centrifugally whirled radially outward and exits through a diffuser part of the casing. As the fluid passes through the impeller it gains velocity and pressure.

Compressible fluid pumps, such as air compressors, operate very differently to incompressible fluid pumps. Their pump components are designed to compensate for and harness the compressibility of the fluid. Incompressible fluid pumps and compressible fluid pumps are not interchangeable.

Over the last century various minor and major designs and modifications to incompressible fluid pumps, including centrifugal pumps, have been trialed and made with various degrees of success. All improvements are largely directed to several key objectives: to make the pump more efficient, and make the pump perform at its best efficiency across a broad range of operating-system characteristics. Where a pump does not produce enough flow discharge or enough pressure, multiple pumps may need to be added in series or in parallel. This can occur where fluid needs to be pumped to a great height such as with waterways pumping stations. Greater output pressure is required to pump the water to the required head.

Pumps have a sweet spot in operational efficiency where they might work well at high velocity flows but are not as efficient at low flows or variable flows. Various operation techniques or additional equipment needs to be employed in order to mitigate wear and damage to the pump when operating outside of its sweet spot.

The present centrifugal pump for incompressible fluids has been brought about by a desire to continue improvements on pump efficiency, usability and/or applicability across a broad range of applications.

### SUMMARY OF THE INVENTION

The present invention provides a centrifugal incompressible fluid pump comprising a casing with a pump inlet and a pump outlet, the casing housing an impeller powered to rotate by a drive system and having a fluid passage between an impeller fluid inlet and a fluid outlet located radially of the fluid inlet; and a recovery by-pass turbine system comprising a recovery by-pass turbine mounted to rotate with the impeller, wherein the recovery turbine system diverts a portion of fluid that has exited the impeller fluid outlet back into the impeller fluid intake, wherein the remaining portion of fluid exits the pump through the pump outlet.

Diverting a portion of fluid through the by-pass turbine instead of the pump's fluid outlet makes use of excess fluid in an application that does not need to operate at maximum pump flow rate. Energy in the excess fluid that by-passes back into the impeller is extracted from the fluid by the by-pass turbine and fed back into the drive system via the impeller. This in turn increases the efficiency of the pump because the diverted fluid, which diverts at a high pressure having already passed through the impeller, transfers energy back into the impeller thereby reducing the power demand on the impeller.

In a preferred embodiment the recovery turbine system includes a valve mechanism to vary the portion of fluid entering the recovery turbine. The valve mechanism may operate between a fully open position, a fully closed position and partially open positions in between open and closed. In effect the valve mechanism imparts on the pump a variable speed function whereby the fluid flowing out of the pump can be controlled according to the output demand of the pump application and in turn the pressure of the output fluid can be kept constant and steady. The valve mechanism preferably also comprises a recovery turbine stator assembly of the by-pass turbine. The by-pass turbine may be a reaction turbine.

The portion of diverted fluid is preferably excess fluid not required to exit the pump for a particular application, that may only require a variable flow, and that is instead diverted through the by-pass turbine system and back into the impeller. As the excess fluid carries with it an amount of energy in the form of pressure, when the excess fluid passes through the recovery turbine system the pressure is converted to fluid velocity, which reduces the demand on the drive system to drive the impeller by extracting energy and passing it on to the impeller shaft and in turn increases the pump's efficiency.

Examples where a variable pump function could be useful include pipelines where fluid flow rates change constantly based on demand, and marine propulsion where water vehicles are driven at variable speeds.

In one embodiment the valve mechanism is controlled by an electronic controller, wherein the controller responds to changes in output pressure. In another embodiment the valve mechanism is controlled mechanically or hydraulically to open in response to a predetermined fluid pressure.

In one embodiment of the pump the by-pass turbine is mounted onto a front end of the impeller and is specifically attached to an impeller shroud. The by-pass turbine and impeller are co-axially mounted so as to rotate together at the same speed. Energy in the high velocity fluid entering the by-pass turbine is recovered by the impeller. The by-pass turbine is a reaction turbine and in this embodiment comprises a tubular casing with a diameter that decreases uniformly along its length from a flared maximum diameter where high velocity fluid enters the turbine to a reduced internal diameter that meets a matching internal diameter of the impeller (where the respective diameters can be the same) so that fluid flows seamlessly from the by-pass turbine into the impeller where it can again be pressurised.

In the above-described embodiment, diverted fluid enters the by-pass turbine at the larger outer circumference towards a front of the tubular casing. The fluid intake or entry point can be through a continuous annular slot at the circumference or a series of openings spaced around the casing's circumference. In a preferred embodiment, provided within the wall of the recovery turbine casing are radially curved runner blades that are angled to receive the striking force of fluid entering passages between the blades and to redirect the fluid radially inward and axially rearward of the by-pass turbine toward the impeller while at the same time rotating under the force of the striking water. Rotation of the turbine imparts a rotational force onto the impeller. Fluid exits the blade passages at a blade fluid outlet that is radially inward and axially rearward of the blade fluid intake and is in line with the tubular inner wall of the by-pass turbine to smoothly direct the fluid into the impeller along the inner wall.

In an embodiment of the invention the valve mechanism in the recovery turbine system comprises a stator assembly. The stator assembly is mounted circumferentially around and coaxially with the by-pass turbine piece, but the stator assembly is fixed to the pump casing to remain stationary. The purpose of the stator assembly is to act as a stator to the by-pass turbine and to also double up as valve to vary the amount of fluid diverted to the by-pass turbine. The stator assembly preferably has a variable width opening controlled by the outlet pressure in the flow path immediately before the stator assembly, which has already exited the impeller.

The stator assembly preferably comprises a two-piece annular sub-assembly, namely a stator outer (also referred to as the stator cylinder with a valve seat) and a stator inner (also referred to as a stator piston with a valve face). The stator pieces are configured to be engaged so that the piston can be moved reciprocally against the cylinder to open and close the valve face against the valve seat thereby opening the valve mechanism to diverting flow through to the by-pass turbine. The stator assembly provides a controlled valve gap that is variable in width for flow control into the by-pass turbine.

The stator assembly also preferably comprises stator blades that convert the pressure energy of the diverted fluid into kinetic energy and direct the high velocity flowing fluid at pre-designed angles to the runner blades in the by-pass turbine. The curvature and angle of the stator blades can be designed according to turbine blade design methods to optimise stator and turbine performance.

In an embodiment of the invention the stator blades are provided on the stator outer, and more specifically on the valve seat facing the stator inner/piston piece. Complementary blade cavities matching the stator blade profiles are machined in the valve face of the piston. The blade cavities are adapted to smoothly receive the stator blades and accordingly the stator cylinder and piston are engaged. The stator assembly is preferably mounted in the pump casing so that the piston is movable relative to the cylinder, with blade cavities guided to slide on the blades, but without the cavities disengaging from the blades. Accordingly, the gap between the valve face (on the piston) and valve seat (on the stator cylinder) can vary between a fully closed position where the valve face and seat lie flush against each other with blades fully inserted in the blade cavities, and a fully open position where the piston has moved away from the stator cylinder to a maximum distance set by a stop defined by the pump casing.

In a preferred embodiment the pump further comprises a fluid turbine positioned adjacent the impeller fluid outlet that is driven by fluid exiting the impeller fluid outlet, wherein power harnessed by the fluid turbine is transferred by a drive output back into the drive system. The impulse turbine is preferably positioned immediately adjacent the impeller outlet such that kinetic energy in the exiting fluid is extracted by the fluid turbine and converted to mechanical work in the drive system. The fluid turbine is preferably an impulse turbine that is positioned upstream from the recovery turbine system. Fluid flowing through the fluid turbine is able to exit the pump through the pump outlet or a portion of the fluid may be diverted from the fluid turbine into the recovery turbine system. In one embodiment, the fluid turbine is immediately upstream from the stator assembly of the recovery turbine system so that it is positioned between the impeller fluid outlet and the recovery turbine system.

High pressure fluid exits the pump outlet which may be a divergent opening off-centre to a longitudinal axis of the pump (where the pump inlet is central of the longitudinal axis for the fluid to access the impeller fluid intake). A pump collection chamber extending as a circumferential volute downstream of the fluid turbine and/or stator assembly to deliver high pressure fluid to the pump outlet. Where extremely high output pressures are required multiple units of the pump could be arranged in series to function as a multistage pump.

The present invention also provides a centrifugal incompressible fluid pump comprising a casing that houses an impeller powered by a drive system and having a fluid passage between a fluid inlet and a fluid outlet located radially of the fluid inlet; and a fluid turbine positioned adjacent the impeller fluid outlet that is driven by fluid exiting the impeller fluid outlet, wherein power harnessed by the fluid turbine is transferred by a turbine drive back into the drive system; wherein the direction of fluid flowing through the impeller fluid passage and through the fluid turbine curves radially in a U-shape direction so that fluid exits the fluid turbine back towards the same direction from which fluid enters the impeller fluid intake.

In a preferred embodiment the fluid turbine is an impulse turbine.

The arrangement of a U-shaped fluid path through the pump means that fluid can enter and exit the pump on the same facing side of the pump, only in opposite substantially parallel directions where fluid enters through an inlet flange toward the housing at the centre of the impeller and fluid exits in an opposite flow direction at an outlet flange radially spaced from the inlet flange. This arrangement allows for a compact pump design where the inlet and outlet are accessible from the same end face of the pump.

To achieve a radially curved flow path that doubles back on itself, the impeller comprises blades contained in a shroud where the blades preferably define a fluid passage that extends rearwardly and radially from the fluid intake at a blade leading edge to the impeller fluid outlet, where the direction of the fluid passage curves in a radial direction through a curvature of between 90°-180°, and preferably by 125°-180° to exit the pumped fluid at the same side of the pump from which it entered but in an opposite direction, and at a higher pressure given the energy pumped into the fluid. It is understood that to obtain the advantage of the present pump the flow path between impeller intake and fluid turbine exit does not need to turn specifically at 180° but could turn through a range that is somewhat more or less than 180°. For example, a tolerance of 5°, or alternatively 10°, or alternatively 15°, more or less than 180° would be acceptable. The point is that the fluid exits the pump from the same direction from which it entered so as to provide for a more compact and convenient pump.

Preferably, as the fluid passage curves from the intake to the outlet it also narrows in width thereby accelerating fluid flow, which creates a jet of fluid exiting the pump.

Where the impeller fluid passage does not turn the full 180°, the fluid turbine can complete the remaining curvature to bring the entire radial U curve to approximately 180°. For example, if the impeller fluid passage turns by 135°, the turbine can be configured in structure to have a curved entry chamber that turns the direction of fluid by approximately 45°. Alternatively, fluid can enter and exit the fluid turbine in a straight direction, which is typical of a standard impulse turbine.

The fluid turbine harnesses a momentum change in the high-pressure fluid exiting the impeller. It does not affect the flow rate in the fluid but will react to the high-pressure fluid by rotating on a turbine axis. Preferably, the fluid turbine is coaxial with an impeller axis. In one embodiment of the invention the drive of the fluid turbine is attached to the pump's drive system, which is preferably a planetary dual drive system.

The pump preferably operates on a single external input drive (e.g., powered by an electric motor, or other common motorised sources), but also draws power from the momentum created by the fluid turbine. In one embodiment an external input drive shaft is fixed to a planet gear carrier that supports three planet gears that in turn drive a central sun gear that is mounted to drive the impeller shaft. In one embodiment the planetary gear arrangement steps up rotation from input drive shaft to impeller shaft by 1-6. For example, an external drive input that rotates the input drive shaft at 1000 rpm will cause the impeller shaft to rotate at 6000 rpm in the same direction.

The fluid turbine drive may be geared or directly connected to the planetary drive system. In one embodiment the fluid turbine drive is connected to the planet carrier to rotate therewith at the same rotation.

### BRIEF DESCRIPTION OF THE FIGURES

In order that the invention be more clearly understood and put into practical effect, reference will now be made to preferred embodiments of an assembly in accordance with the present invention. The ensuing description is given by way of non-limitative example only and is with reference to the accompanying drawings, wherein:

FIG. 1 illustrates a front isometric view of a centrifugal incompressible fluid pump in accordance with the present invention;

FIG. 2 illustrates a rear isometric view of the centrifugal incompressible fluid pump;

FIG. 3 is a front isometric cutaway view of the planetary dual drive system of the centrifugal incompressible fluid pump;

FIG. 4 is a rear isometric cutaway view of the planetary dual drive system;

FIG. 5 is a front isometric view of the planetary drive system without the cutaway;

FIG. 6 is a front complete isometric view of a gear box of the fluid pump containing the planetary drive system;

FIG. 7 is a front isometric cutaway view of the gearbox;

FIG. 8 is a similar view to FIG. 7 and also illustrating a fluid pump impeller and a fluid turbine drive, where the fluid turbine drive is mounted to a first output drive of the gear box and the impeller is mounted to a second output drive of the gear box;

FIG. 9 is a similar view to FIG. 8 and also illustrating a fluid turbine mounted to the assembly of the fluid pump;

FIG. 10 is a similar view to FIG. 9 and also illustrating a recovery turbine attached to the impeller;

FIG. 11 is an enlarged view of FIG. 10 and also illustrating a by-pass turbine casing removed to expose the by-pass turbine blades;

FIG. 12 is an enlarged view of FIG. 11 and also illustrates further details of a recovery by-pass turbine system including by-pass turbine blades and part of a valve mechanism;

FIG. 13 is a similar view to FIG. 12 illustrating still further details of a recovery turbine system including the complete valve mechanism;

FIG. 14 is a front isometric cutaway view of the entire centrifugal incompressible fluid pump showing internal components;

FIG. 15 is an isometric view of the front end of the fluid pump;

FIG. 16 shows enlarged area A in FIG. 15;

FIG. 17 is an isometric view of a stator assembly and by-pass turbine of a recovery by-pass turbine assembly;

FIG. 18 is an isometric view of the stator assembly without the by-pass turbine;

FIG. 19 is an isometric exploded view of the stator assembly;

FIG. 20 is a sectioned isometric view of exploded parts of the stator assembly;

FIG. 21 is a sectioned isometric view of the stator assembly parts in assembly alignment;

FIG. 22 is a sectioned isometric view of the stator assembly parts after alignment and at initial engagement;

FIG. 23 is a sectioned isometric view of the stator assembly parts forming the fully open position of the valve mechanism;

FIG. 24 is a sectioned isometric view of the stator assembly parts forming the fully closed position of the valve mechanism;

FIG. 25 shows results of a first, second, third and fourth test simulation of an embodiment of the fluid pump, where the results of the tests are respectively shown in Tables 1, 2, 3 and 4; and

FIG. 26 is a graph illustrating pump efficiencies of four pump arrangements (simulations 1, 2, 3 and 4) across a range of mass flow rates.

### DETAILED DESCRIPTION

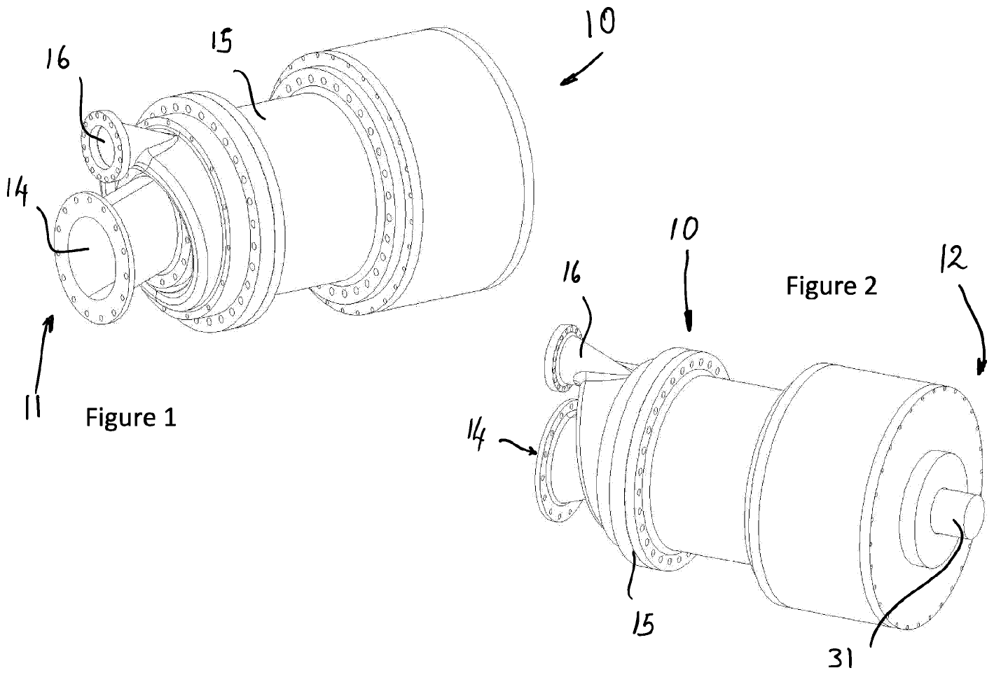

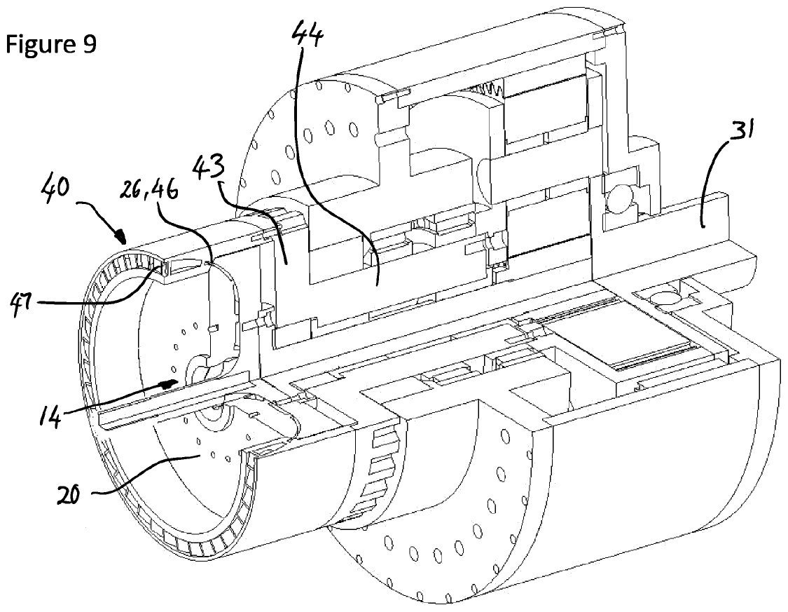

A full and encased representation of a centrifugal incompressible fluid pump 10 is illustrated in FIG. 1 from a front, fluid pumping end 11 of the pump 10 and in FIG. 2 from a rear, driving end 12 of the pump 10. The pump 10 is designed to pump incompressible fluids, such as liquids like water, other aqueous fluids and oils. It is understood that any incompressible fluid can be pumped using the described fluid pump 10. Fluid to be pumped enters (often under a system head) through a pump inlet 14 in a pump housing 15 and exits from a pump outlet 16. Between the inlet 14 and outlet 16 the fluid passes through a fluid passage 18 (described in more detail below) where the flow rate of the fluid is accelerated by an impeller 20 (FIG. 9) under centrifugal force and exits the outlet 16 at a greater pressure than what it had when it entered the inlet.

The pump is powered to increase the energy (pressure and velocity) in the fluid exiting the pump by way of a single external drive input. That drive input, which may be an electric motor or an engine, is coupled to the pump's drive system 30, of which an external input drive shaft 31 is illustrated in FIG. 2. The efficiency of the pump can be quantified as the ratio of useful hydraulic power that is delivered to the fluid to the power input at the drive shaft.

The present invention aims to employ one or more techniques for improving the efficiency of an incompressible fluid pump. An advantage of improvements to efficiency is that the pump can usefully be used as a single stage pump to the equivalent power of many known pumps used in multiple stages.

The description that follows and the drawings describe one embodiment of centrifugal fluid pump. The pump is designed to operate with incompressible fluids and is unlikely to function using compressible fluids as gas.

### Drive System

The planetary dual drive system 30 will be described first to provide an understanding of how the fluid pump 10 is powered to start up and to operate once started. A motor (not shown) or other external input drive is attached to and drives the external input drive shaft 31. While there is only intended to be one external input drive into the drive system, the system is a dual drive system in that it powers both the impeller 20 but also a fluid turbine 40, at least on start up. After the pump system is running at speed and the fluid turbine is fully operational in that it is driven by the output fluid from the impeller, the fluid turbine recovers kinetic energy from the flowing fluid back into the drive system. In other words, the fluid turbine supplements the energy of the drive system.

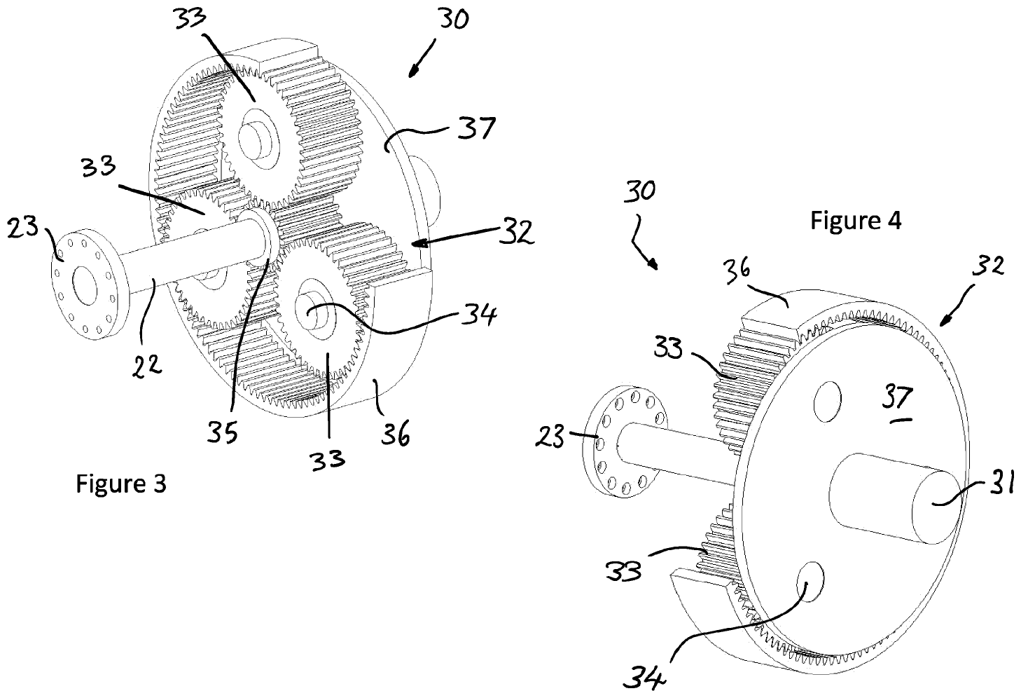

As shown in FIG. 3 and FIG. 4, the external input drive shaft 31 is fixed to a planet gear carrier 32 having a ring gear 36 that supports three planet gears 33 via planet pins 34. The planet gears 33 rotate to idle with the planet gear carrier and are geared to a central sun gear 35 that is mounted around an end of an impeller shaft 22. The opposite end of the impeller shaft has a shaft flange 23 onto which the impeller 20 is mounted to rotate. The gear ratio of the planetary gear system illustrated in the drawings results in an approximate 5:1 gear reduction. Being a planetary gear system, this results in a gear ratio of approximately 1:6. In the particular embodiment illustrated, and that used in the CFD analysis explained further below in Example 1, the actual gear ratio used is 1.75:6.

The output speed of the impeller can be calculated using the known input speed of the external input drive and the gear ratio according to the following equation:

Sₒ=Sᵢ/r
Where:
Sᵢ=input speed (rpm—revolutions per minute)
Sₒ=output speed (rpm)
r=gear ratio

Taking by way of example an input drive speed at the input drive shaft of 1750 rpm and a gear ratio of 1.75:6 (or 1:3.43), the rotating output speed of the impeller will increase to 6000 rpm in the same direction.

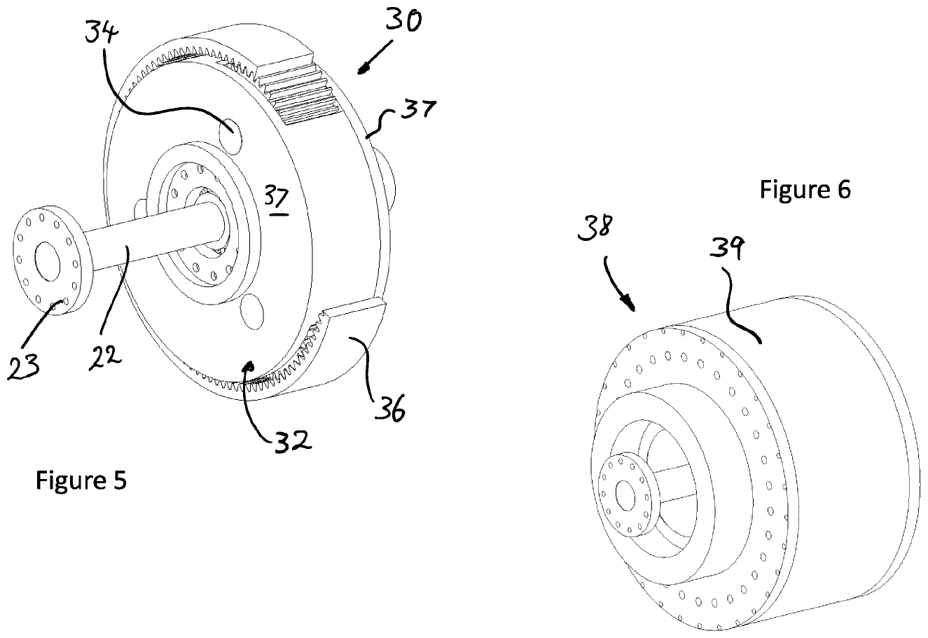

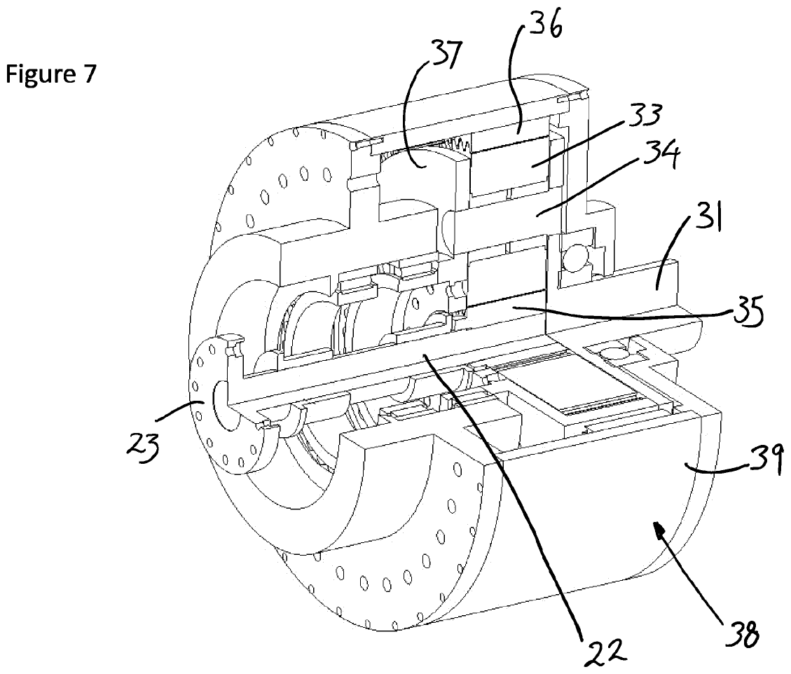

FIG. 5 illustrates the complete planet carrier 32 without any cutaway portions (which are cutaway in FIGS. 3 and 4) and having two facing plates 37 between which the planet gears 33 and sun gear 35 are mounted. FIG. 6 illustrates the complete gear box 38 in gear box housing 39. FIG. 7 shows in partial side sectional view how the impeller shaft 22 is connected to the planetary drive system.

### Impeller

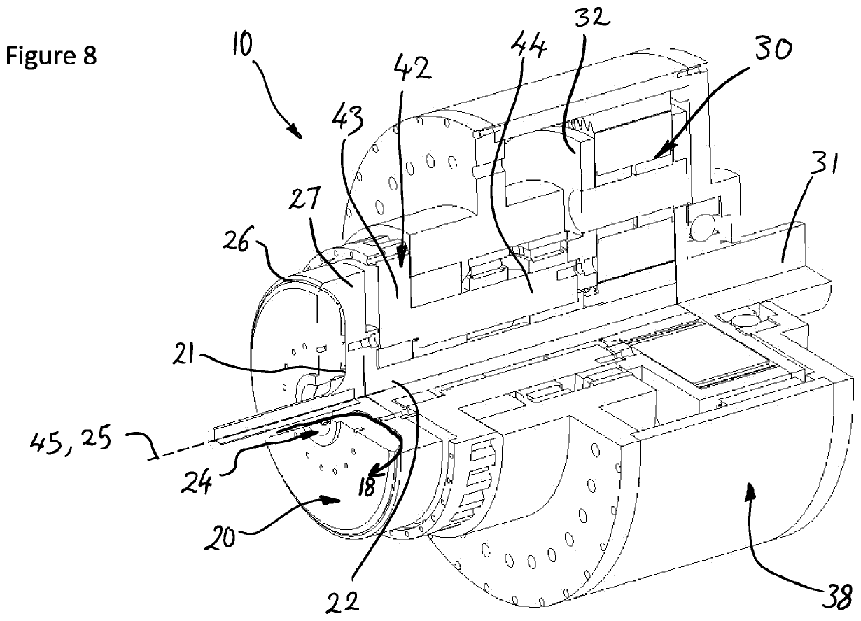

FIG. 8 is a partial longitudinal section view showing the impeller 20 through which fluid in centrifugally rotated to increase the pressure of the fluid the pump 10. Fluid enters the pump through the pump inlet 14 and is drawn into an impeller inlet 24 of impeller 20 under the centrifugal force of the rotating impeller driven by the drive system. The fluid then travels under centrifugal forces through the fluid passage 18 in a radially outward direction of the impeller's rotating axis 25 to exit at an impeller outlet 26.

The impeller comprises blades 21 contained in a full shroud 27, all of which is driven to rotate through impeller shaft 22. The blades are back-swept blades and act as guide vanes constrained by the shroud acting as a housing to guide fluid along passage 18 from its axial direction at pump entry, rearwardly and turning the fluid to a radial direction to exit the impeller outlet 26 radially spaced from the axially central impeller inlet. The spacing between the blades 21, and between the blades 21 and the shroud 27, narrows further from the impeller axis 25 thereby increasing the fluid pressure which exits the impeller outlet 26 as a jet of fluid.

It can be seen (in FIG. 8) that the fluid flow path 18 enters axially of the impeller 20, curves outwardly as it is centrifugally accelerated and then, unlike in known pumps, continues to turn radially in a “U” direction to exit the pump from the same end through which it entered (namely, the pumping end 11) but travelling in the opposite direction.

The U-shaped flow of the fluid is a function of the impeller outlet 26 having a reverse turned tail end that feeds towards the pump outlet 16. In the embodiment illustrated in the drawings (from FIG. 9 onward) the impeller outlet 26 fees into the fluid turbine 40. The impeller blades 21 extend rearwardly and radially from the impeller fluid inlet 24 at a blade leading edge to double back the fluid passage 18 in a U-shape and exit at the impeller fluid outlet. The fluid turbine may also contribute to the U-shaped curve of the fluid passage. The direction of the fluid passage curves in a radial direction by between 90°-180°, and in the illustrated embodiment curves 125°-180° to propel the pumped fluid out the same side of the pump from which it entered but in an opposite direction, and at a higher pressure given the energy pumped into the fluid.

In the embodiment illustrated, the geometry of the impeller outlet 26 curves to orient the outlet 26 back towards the impeller inlet 24. The curvature of the impeller at and immediately before the outlet 26 defines the U-shape return of fluid passage 18. However, it is understood that other embodiments are possible where the outlet 26 geometry accounts for 75%-100% of the final return curve, and the fluid turbine and/or pump housing accounts for the remaining 0%-25% return curve. The U-shaped fluid passage 18 brings about a far more compact and conveniently configured centrifugal pump than known axial flow pumps, radial flow pumps or mixed flow pumps.

### Fluid Turbine

FIG. 8 also shows where the fluid turbine drive is positioned relative to the drive system 30 and impeller shaft 22. The fluid turbine 40 is not illustrated in FIG. 8. Fluid turbine drive 42 is concentrically mounted around impeller shaft 22 and comprises a turbine attachment flange 43 and hollow turbine drive shaft 44, which defines a fluid turbine axis 45. The attachment flange 43 keys into and attaches to the fluid turbine 40. At an opposite end to the attachment flange 43 the turbine drive shaft 44 is attached to the planet carrier 32 such that the fluid turbine rotates with the planet carrier.

Accordingly, upon start-up of the pump 10 the planet carrier will cause fluid turbine 40 to rotate at the same speed and in the same direction as the planet carrier. The purpose of the fluid turbine is to harness the power of the energy in the high velocity fluid exiting the impeller and to pass that energy back into the drive system 30 via fluid turbine drive 42 in order to reduce the overall load on the pump and increase the effective efficiency of the pump 10 as a system.

The fluid turbine 40 is first shown in FIG. 9. In the embodiment illustrated in the drawings the fluid turbine 40 is an impulse turbine. Impulse turbines spin from jets of fluid entering the turbine and striking Pelton wheels which change the direction of the high flowing fluid without changing the pressure. The spinning fluid turbine 40 causes the turbine drive 42 to rotate which in turn imparts rotational energy to the drive system 30 thereby reducing the load on the external drive source and improving the efficiency of the pump.

The fluid turbine rotates at a slower speed than the impeller and will specifically rotate at the same gear ratio as the external input drive shaft to the impeller. Taking the earlier example of the input drive shaft rotating at 1750 rpm which steps up the impeller shaft speed to 6000 rpm, in this example the fluid turbine will rotate at 1750 rpm.

In the presently described centrifugal pump the fluid turbine is positioned around the impeller 20 and rotates coaxially with the impeller so that fluid entering centrally of the impeller and accelerating centrifugally out an impeller outlet 26 will then immediately enter the fluid turbine at a fluid turbine entry 46 as a fluid jet where momentum in the fluid jet imparts a rotating force on the fluid turbine before leaving the fluid turbine through a turbine exit 47 and exiting the pump at an increased head and pressure. By impacting the impulse fluid turbine the flow direction changes by about 90°.

However, the entry 46 and exit 47 of the fluid turbine will be spaced substantially the same distance in an axial direction. By axial direction it is meant the entry 46 and exit 47 are spaced the same distance from the impeller/fluid turbine axes (which lie on the same axis), save for any variations due to the fluid turbine's contribution to completing the U-shape fluid passage. In other words, the fluid path between the turbine entry 46 and turbine exit 47 is substantially parallel aligned with the impeller/fluid turbine axes 25, 45. Hence fluid exiting the pump 10 will exit through the pump outlet 16 from the same end of the pump but spaced radially from the central pump inlet 14.

### Recovery By-Pass Turbine

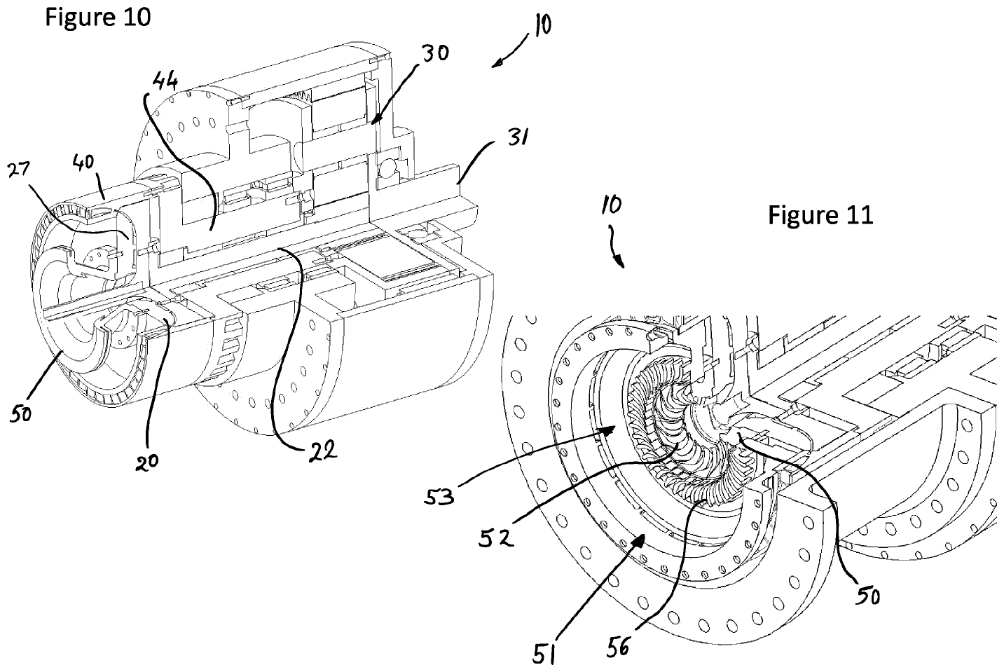

A by-pass turbine 50 as illustrated in FIG. 10 to FIG. 24 increases the functional efficiency of the pump 10 by in effect delivering a variable speed function whereby the pump can operate to increase or decrease performance based on power demand at the outlet. The function of the by-pass turbine 50 is to divert a portion of fluid downstream from the impeller and fluid turbine (if provided) back into the impeller instead of pumping excess fluid through the pump's outlet 16.

For example, the pump could be used in marine propulsion. A cruising marine vehicle will not need as much fluid jet power as an accelerating vehicle. Fluid surplus to maximum requirement can be diverted through the by-pass turbine in order to reduce the power demand on the impeller. This in turn reduces the pump's power input from the external drive source which will overall increase the pump's efficiency. In this example, the option of by-passing surplus fluid through the by-pass turbine is more favourable than simply throttling the output flow. Throttling the output flow consumes more fuel which will decrease the drive system's efficiency. To maximise efficiency the engine is run at its ideal condition while the recovery by-pass system in the pump takes care of the energy dynamics and output flow requirements.

FIG. 10 illustrates the by-pass turbine 50 mounted onto a front end of the impeller shroud 27. The by-pass turbine 50 is a reaction turbine and is co-axially mounted with the impeller 20 so they rotate together at the same speed. Energy in the high velocity fluid entering the by-pass turbine is recovered by the impeller. As is seen in FIG. 10, by-pass turbine 50 comprises a tubular casing having a diameter that decreases uniformly along its length from a flared maximum diameter where high velocity fluid enters the turbine to a reduced internal diameter that meets the same internal diameter of the impeller. In this way fluid travelling between the by-pass turbine 50 and impeller 20 can flow without interruption into the impeller where it will again be pressurized.

The by-pass turbine 50 is part of a recovery turbine system 51 that also includes a recovery stator assembly that directs fluid from the turbine exit into the by-pass turbine at the correct entry angle matching the by-pass turbine runner blades 52 as shown in FIG. 11. The stator assembly is mounted circumferentially around and coaxially with the by-pass turbine 50 but is fixed to the pump casing to remain stationary. The purpose of the stator assembly is to act as a stator to the by-pass turbine and to also act as valve mechanism to vary the amount of fluid diverted to the by-pass turbine. As a valve mechanism, the stator assembly has a variable width opening controlled by the outlet pressure in the flow path immediately before the stator assembly, which has already exited the impeller.

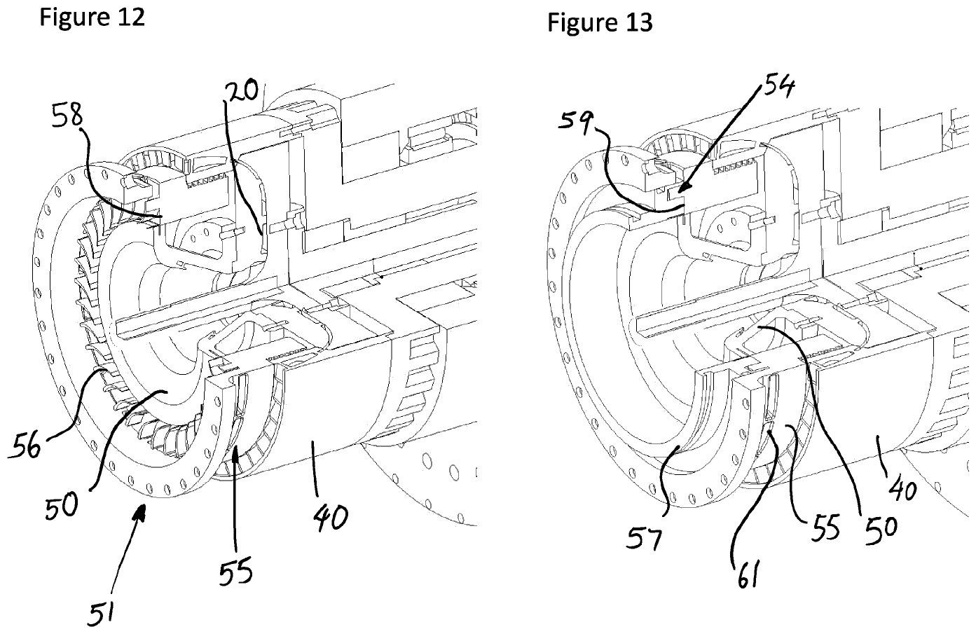

The stator assembly comprises a two-piece annular sub-assembly, namely a stator outer 55 (also referred to as the stator cylinder with a valve seat 58) and a stator inner 57 (also referred to as a stator piston with a valve face 59). FIG. 12 illustrates one part of the stator assembly 53 and namely the stator outer 55 which is also the cylinder providing the valve seat of the valve mechanism 54. The stator blades 56 are clearly seen at a forward-swept angle to direct high pressure fluid into the spinning by-pass turbine.

FIG. 13 shows the other half of the stator assembly, and namely the stator inner 57, which also serves as the piston of the valve mechanism 54. The stator parts are configured to be engaged so that the piston 57 can be moved reciprocally against the stator cylinder 55 to open and close the valve face 59 against the valve seat 58 thereby opening the valve mechanism to diverting flow through to the by-pass turbine. The stator assembly provides a controlled valve gap that is variable in width for flow control into the by-pass turbine 50. The stator blades 56 of the stator assembly additionally ensure the flow entering the by-pass turbine is angled and directed for optimum transition into the by-pass turbine.

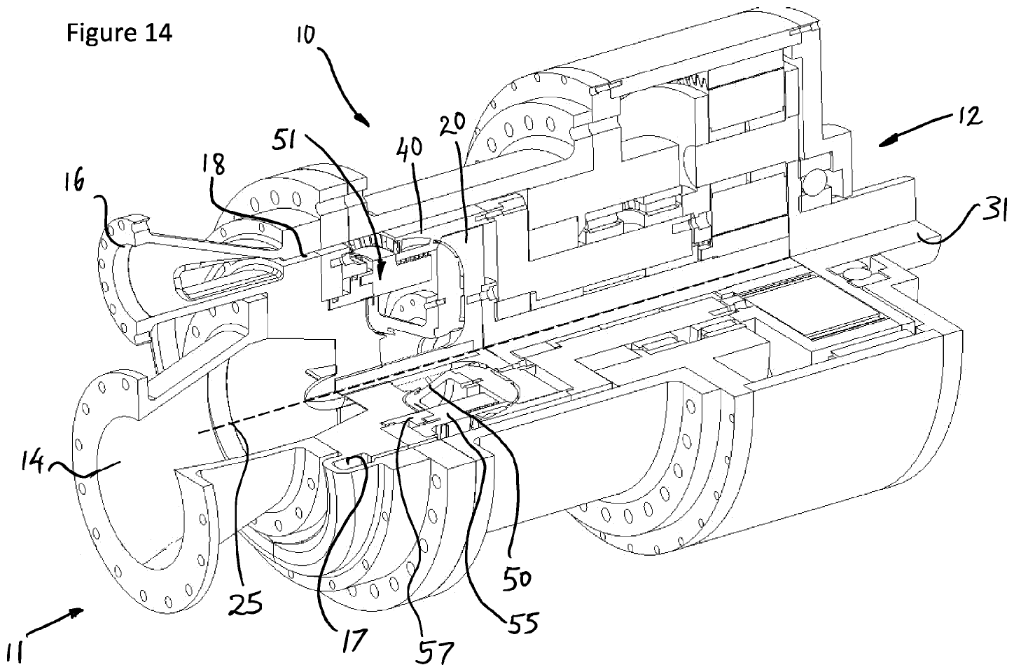

FIG. 14 is a useful view illustrating the entire centrifugal pump 10 from the driving end 12 to the pumping end 11 including the pump inlet flange 14 which receives fluid into the impeller and the high pressure pump outlet flange 16, which is radially spaced from the pump inlet 14 and off-centre from the pump's longitudinal axis (defined by the impeller axis 25) but provided on the same facing side of the pump so that fluid enters and exits the pump from the same end, and in the embodiment shown, in parallel directions. Also shown is the circumferential volute fluid collection chamber 17 which collects the high pressure fluid downstream of the impeller, fluid turbine and by-pass turbine and funnels the fluid toward the high pressure pump outlet 16 for use in the desired pump application.

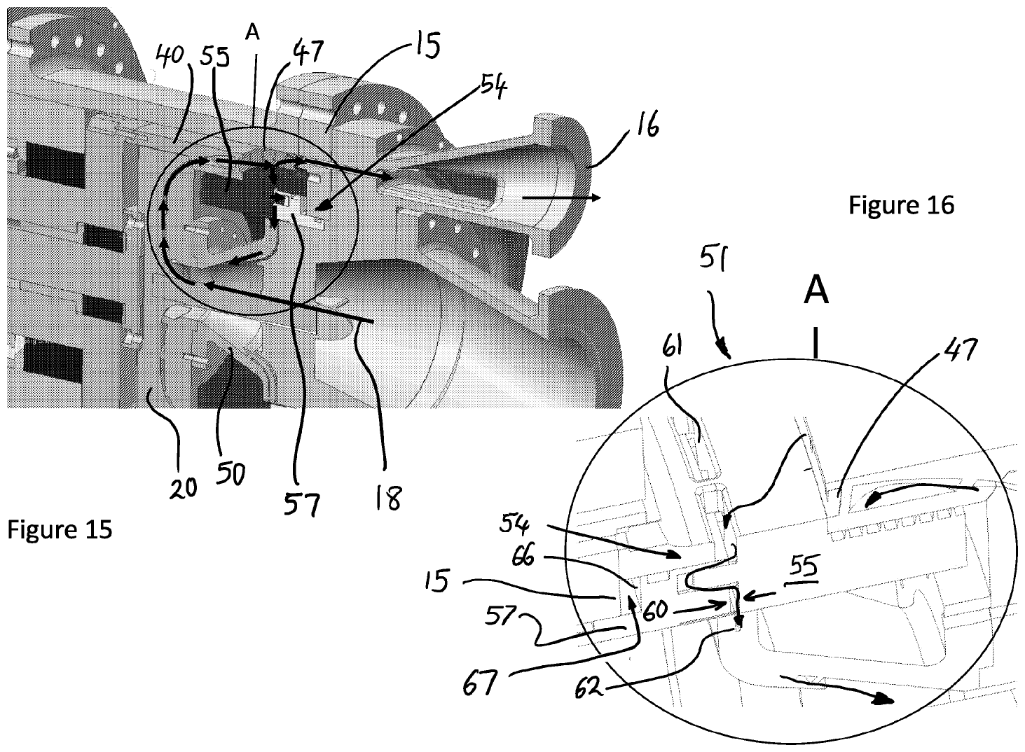

High pressure fluid leaving the fluid turbine 40 is propelled through the fluid collection chamber 17 and out of the pump outlet 16. If the valve mechanism 54 of the recovery by-pass turbine system 51 is open, a portion of fluid (which will depend on the amount the valve mechanism is opened) will diverge through the stator assembly 53, through the by-pass turbine 50 and back into the impeller 20 to recirculate and pressurize again. The exiting and diverging fluid passage 18 is illustrated in FIG. 15 and FIG. 16.

FIG. 15 and FIG. 16 are enlarged views showing the recovery turbine system 51. High pressure fluid exiting the fluid turbine exit 47 flows towards the pump outlet 16 but if the valve mechanism 54 is open an amount of fluid will be drawn through a stator fluid entry 61, which includes a series of long openings around the circumference of the stator outer 55. Fluid flows through fluid entry 61 and passes through a gap 60 located between the fixed stator outer/cylinder 55 and the movable stator inner/piston 57. The stator inner 57 moves reciprocally toward and away from the stator outer thereby closing the gap completely or opening the gap 60 to a maximum, or any gap opening in-between.

Once the diverted fluid passes through the gap 60 it enters the rotating by-pass turbine 50 at the turbine's larger outer circumference towards a front of the tubular casing. The fluid intake into the turbine is through a substantially continuous annular slot 62 at the casing's circumference. Provided within the wall of the recovery turbine casing are the radially curved runner blades 52 described earlier that are angled to receive the striking force of fluid entering passages between the blades and to redirect the fluid radially inward and axially rearward of the by-pass turbine toward the impeller while at the same time rotating under the force of the striking water. Fluid exits the blade passages at a blade fluid outlet that is radially inward and axially rearward of the blade fluid intake and is in line with the tubular inner wall of the by-pass turbine to smoothly direct the fluid into the impeller along the inner wall.

By virtue of it being mounted onto the impeller, rotation of the by-pass turbine imparts a rotational force onto the impeller transferring energy to the impeller.

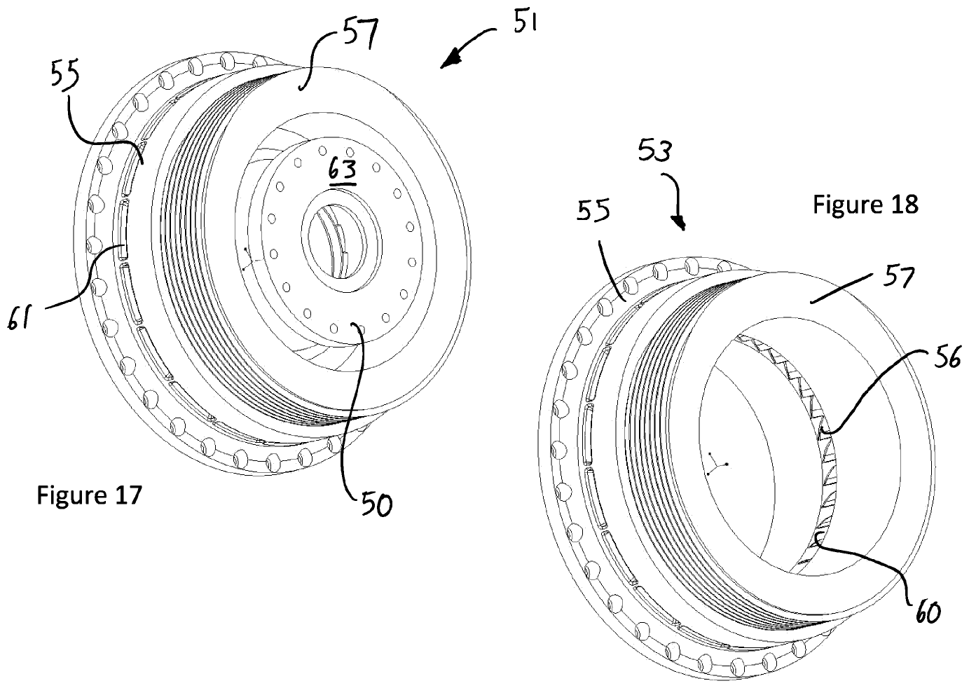

FIG. 17 to FIG. 24 illustrate the assembly of the recovery turbine system 51 removed from the pump 10.

In FIG. 17 the by-pass turbine 50 is illustrated located concentrically inside the assembly of the stator outer 55 and stator inner 57. The view shows mounting face 63 of the by-pass turbine 50, which is mounted onto the impeller shroud 27. FIG. 18 illustrates the stator assembly 55, 57 without the by-pass turbine 50. Stator blades 56 can be clearly seen through the open gap 60 between the inner and outer stator parts. In this figure the stator outer 55 and stator inner 57 are engaged but with the valve face and valve seat separated to form gap 60.

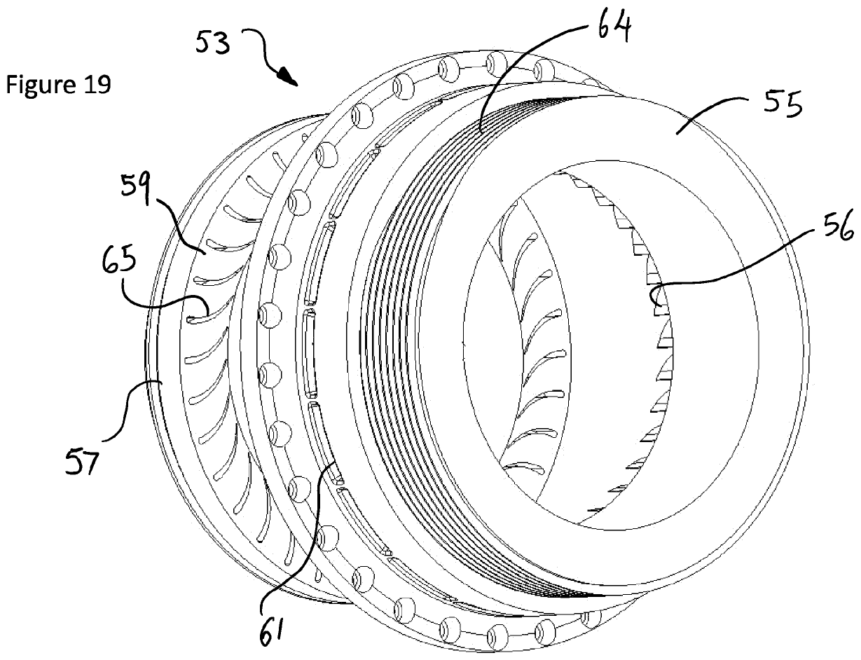

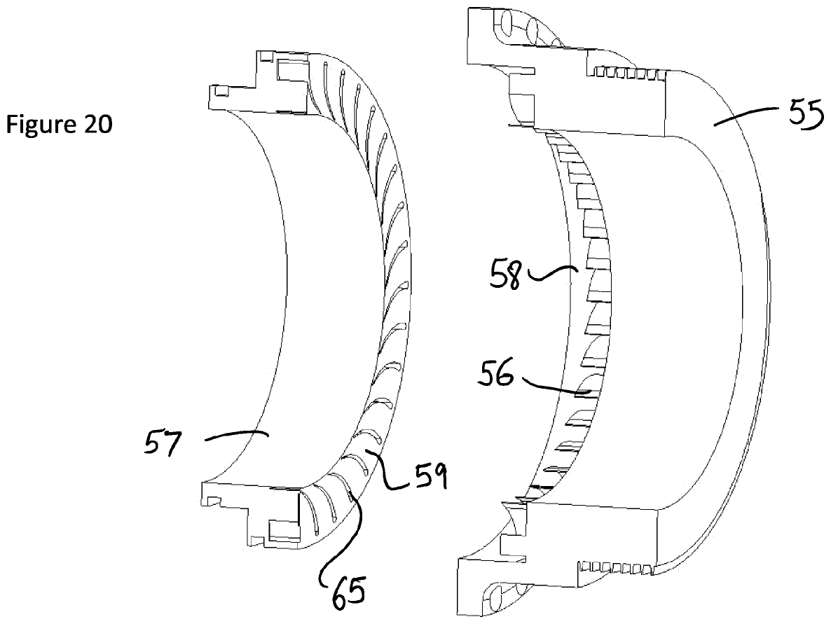

FIG. 19 illustrates the stator outer 55 and stator inner 57 in a separated state to better illustrate their features and how they respectively operate as a cylinder and piston. The stator outer 55 comprises an annular cylindrical casing to concentrically and reciprocally receive the annular piston insert that is the stator inner 57. The fluid entry 61 openings are seen on the outer circumference of the stator outer and a thread 64 on the stator outer is adapted to engage with the pump housing 15. The stator blades 56 can be seen carried on the valve seat 58 of the stator outer 55. Stator blades 56 are received in corresponding and matching blade cavities 65 machined into the valve face 59 of the stator inner. The blade cavities 65 are adapted to smoothly receive the stator blades and accordingly the stator cylinder and piston are engaged.

FIG. 20 to FIG. 24 show the two stator halves (inner and outer) with radially cutaways for clarity. In FIG. 20 the halves are entirely separated to clearly show the arrangement of the stator blades 56 on valve seat 58 and blade cavities 65 in valve face 59.

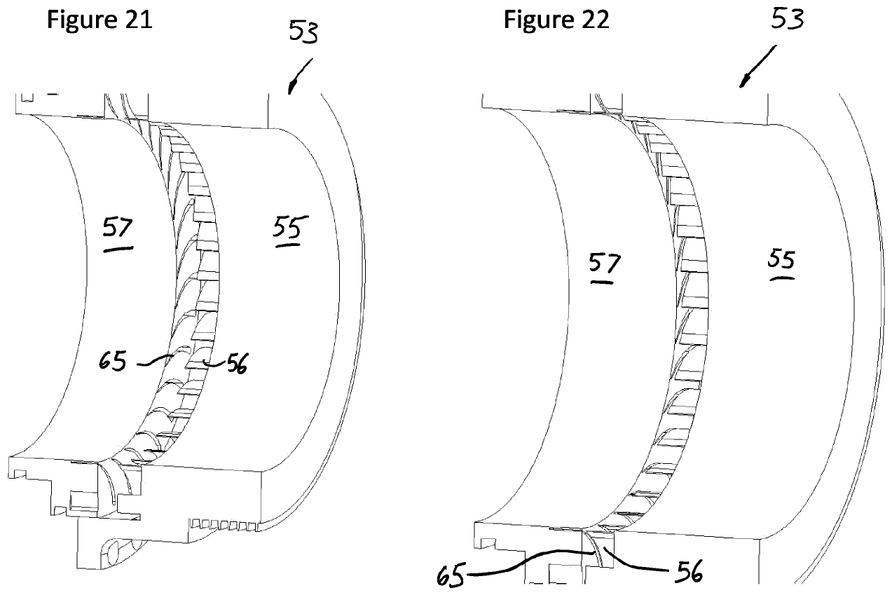

FIG. 21 shows how the inner and outer stator parts are initially assembled by aligning the blades 56 with cavities 65, while FIG. 22 shows the blades entering the cavities. Once inserted the stator sub-assembly is mounted into the pump housing and the two stator parts never disengage because the blade length is greater than the piston stroke to open and close the gap 60.

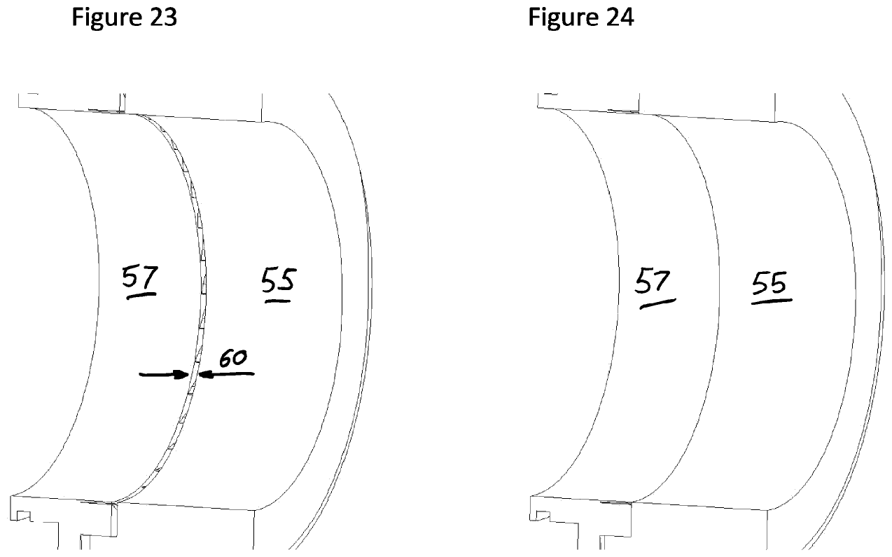

FIG. 23 illustrates the stator outer 55 fully engaged with the stator inner 57 and showing the controlled valve gap 60 in the maximum open position. FIG. 24 is a similar view but showing the valve gap in the fully closed position where the valve face and valve seat lie flush against each other. The pump housing 15 will determine the end of the piston stroke in the fully open position by acting as a stop against which the piston can no longer move. Referring specifically to FIG. 16, an outer rim 66 of the stator inner/piston can be seen almost abutting the housing 15 in an annular piston recess 67 in the housing 15. At this position the piston is almost at the end of the piston stroke.

Throughout the drawings provision is shown for high pressure seals and bearings for rotational support. While not specifically referenced it is understood a skilled person will understand where seals, bearings and suitable lubrication will need to be applied.

The valve mechanism is controlled by an electronic controller which responds to changes in output pressure detected by sensors and adjusts the gap size by hydraulically moving the stator inner towards or away from the stator outer.

Example of Pump Performance using Test Simulations

Test simulations were performed in a computation fluid dynamics (CFD) program using the pump 10 illustrated in the drawings. Power to the external input source produced an input speed at the drive system's input drive shaft of 1750 rpm. The power transferred through the drive system to the impeller produce a speed at the impeller shaft of 6000 rpm. This is in line with the gear ratio described earlier under ‘Drive System’.

Four simulations were conducted in various pump arrangements. These were:
Simulation 1— Impeller only
Simulation 2— Impeller+fluid turbine (no by-pass recovery turbine)
Simulation 3— Impeller+fluid turbine +by-pass recovery turbine system
Simulation 4— Impeller+by-pass recovery turbine system (no fluid turbine)

In the simulated pump the outer diameter of the impeller at the impeller outlet measured at 575 mm. The diameter of the impulse/fluid turbine at its outlet measured approximately 600 mm. The internal diameter of the by-pass turbine was 115 mm and the outer diameter of the recovery stator was 375 mm.

The test simulations were simulated for pumping water at approximately 20° C. under the constraints of the following constant parameters:
Input drive shaft speed=1750 rpm
Impeller shaft speed=6000 rpm
Output Fluid Pressure, p=125 atm
Output Head, h=1291.875 m
Mass flow rate, q=20, 40, 60, 80 and 105 litres/sec

Power and efficiency measurements were calculated across low to high outflow rates, q, by specifically measuring impeller and turbine torque values at mass flow rates of 20, 40, 60, 80 and 105 litres/sec.

### Simulation 1

The first test simulation involved running the pump 10 with the impeller 20 only and without the fluid turbine 40 or recovery by-pass turbine 50. This test was to produce a benchmark from which to compare the changes in efficiency by adding the fluid turbine and by-pass turbine. The pump outlet 16 is throttled to achieve mass flow rates of 20, 40, 60, 80 and 105 litres/sec.

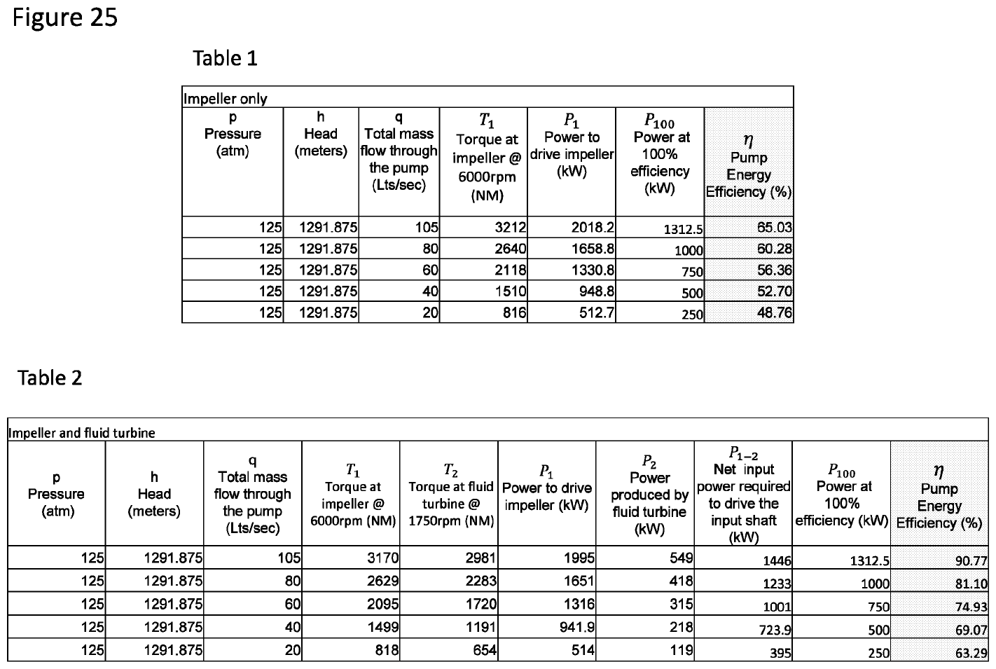

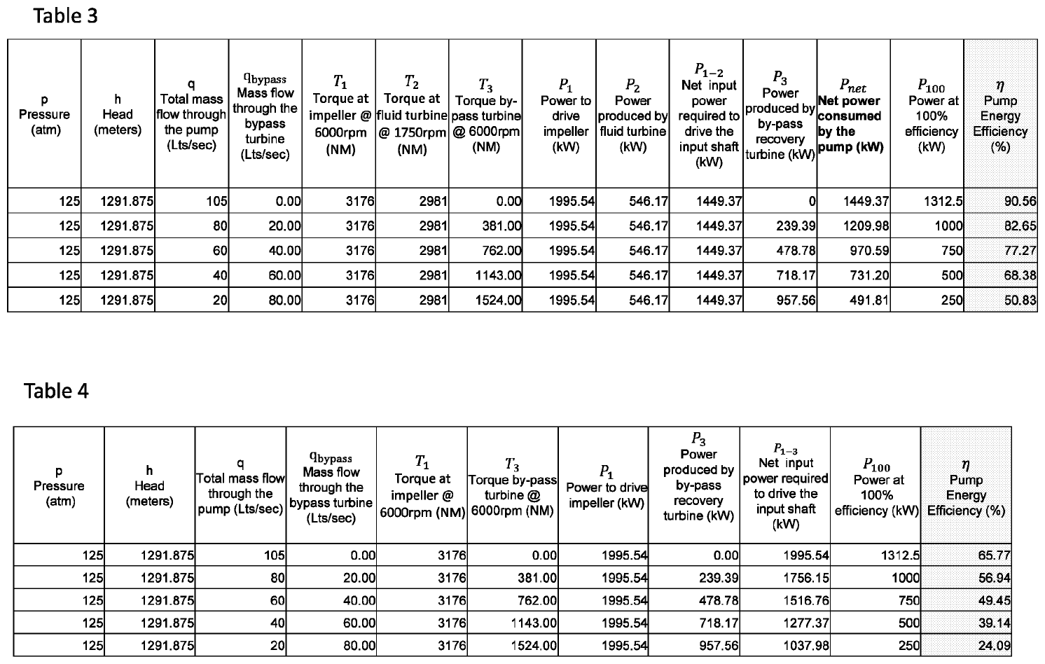

The results of the first test simulation running the impeller only are shown in Table 1 of FIG. 25.

The values in Table 1 represent the following:
T₁=Torque (negative) measured at the impeller input shaft rotating at 6000 rpm (NM)
P₁=Power to drive impeller shaft (kW)
P₁₀₀=Power demand at 100% pump efficiency
η=pump energy efficiency
Where:

$${P}_{1} = \frac{{T}_{1} \times 2 π \times rpm}{60 \times 1000}$$

And:

$${P}_{100} ( kW ) = \frac{h \times q \times ρ g}{1000}$$

Where pg=specific weight of water, which @ 20° C. is 9.807 kN/m3
Or:

$${P}_{100} ( kW ) = \frac{p \times q \times 60}{600}$$

Where:

$$η = \frac{{P}_{100}}{{P}_{1}}$$

The power calculations shown in the Tables of FIG. 25 were derived using CFD software based on the above equations. Slight discrepancies may be found between the CFD-calculated power values compared to using the pressure, head and mass flow parameters shown in the tables. This can be accounted by the CFD software using pressure, head and mass flow values close to the values shown in the Tables but not necessarily exactly those values, which in the Tables are rounded to the nearest whole integer.

Table 1 shows the efficiency of the pump operating only with the impeller ranges between 48.76% and 65.03% over a flow rate range of 20-105 litres/second.

### Simulation 2

The second simulation involved the pump 10 running with the impeller 20 and with the fluid turbine 40, which harnesses energy from the high velocity fluid exiting the impeller and adds that energy back into the drive system, effectively measured at the external input drive shaft 31.

The results of the second test simulation running the impeller and the fluid turbine are shown in Table 2 of FIG. 25. As with simulation 1, in simulation 2 the mass flow rate was varied between 20-105 litres/sec by throttling the pump outlet. Parameters in Table 2 with the same reference as in Table 1 represent the same parameters. Table 2 additionally shows the following parameters:
T₂=Torque (positive) measured at the fluid turbine shaft rotating at 1750 rpm (NM)
P₂=Power produced by the fluid turbine (kW)
P₁₋₂=Net input required to drive the input shaft, namely P₁-P₂ (kVV)
Where:

$${P}_{2} = \frac{{T}_{2} \times 2 π \times rpm}{60 \times 1000}$$

Table 2 shows that when compared against Table 1 the overall efficiency of the pump increases significantly across the range of mass flow rates through the pump. At the top flow rate of 105 litres/sec the pump efficiency has increased by 25.74%.

### Simulation 3

The third simulation involved the pump 10 running with the impeller 20 and with both the fluid turbine 40 and by-pass turbine system 51. The by-pass turbine, which extracts energy from diverted, surplus fluid flow just before the outlet and adds that energy back into the pump system, was set at various diversion rates to produce mass flow rates through the pump of 20, 40, 60, 80 and 105 litres/sec.

The results of the third test simulation running with all pump components including impeller, fluid turbine and by-pass turbine are shown in Table 3 of FIG. 24. Parameters in Table 3 with the same reference as in Table 2 represent the same parameters. Table 3 additionally shows the following parameters:
q_{bypass}=mass flow through the by-pass recovery turbine
T₃=Torque (positive) measured at the by-pass turbine shaft rotating at 6000 rpm (NM)
P₃=Power produced by the by-pass turbine (kW)
Pₙₑₜ=Net power consumed by the pump, namely P₁-P₂-P₃ (kW)
Where:

$${P}_{3} = \frac{{T}_{3} \times 2 π \times rpm}{60 \times 1000}$$

Table 3 shows the efficiency η of the pump with impeller and both turbines operating in simulation 3. In this arrangement the impeller 20 and the fluid turbine 40 run at full flow and full pressure regardless of mass flow rate through the pump system. This is because when a lower output is required the by-pass turbine will recover energy by redirecting fluid back into the impeller, which will continue to operate at full flow and pressure.

While the efficiencies of simulation 2 appear slightly higher than those of simulation 3, in practice it is predicted that the pump of simulation 2 is more suited to short term use pumps and may not be sustainable in the long term to deliver sufficient fluid pressure over long periods. For short term applications the pump of simulation 2 may be suitable. However, for pump longevity and to maintain as high a head as possible across as broad a flow rate range as possible, the pump of simulation 3 is more suitable.

It is noted that efficiency results of both simulations 2 and 3 significantly improve on the efficiency results of simulation 1.

### Simulation 4

The fourth simulation involved pump 10 running with impeller 20 together with the recovery turbine system 51. Table 4 of FIG. 25 shows the results of the fourth simulation. These results show that while it is possible to run a pump with the fluid diversion feature of the recovery turbine system, the efficiency compared to not incorporating the recovery turbine system is only favourable at high total mass flow rates through the pump.

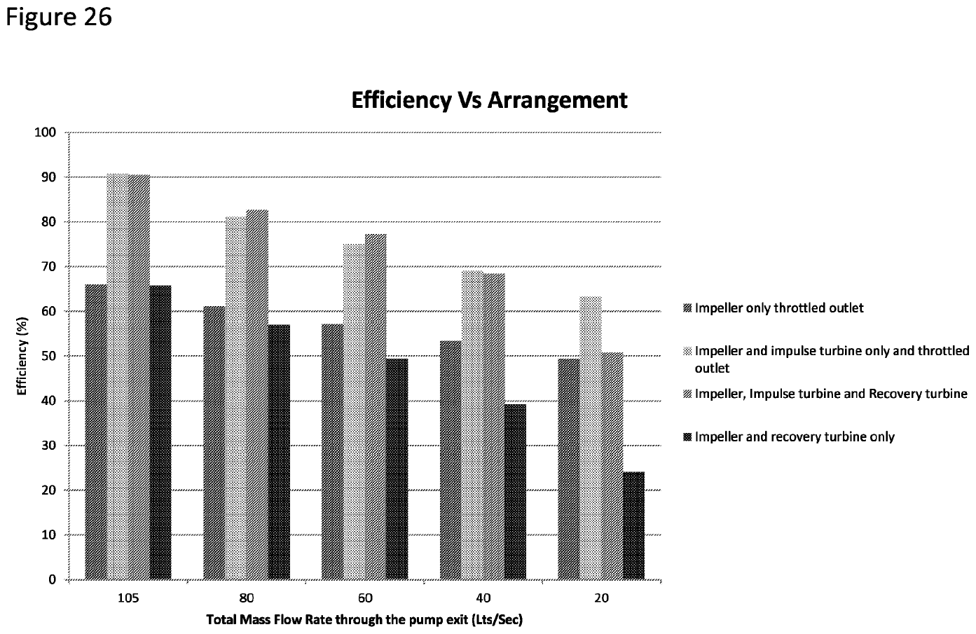

By way of illustration, the relative efficiencies of all four simulations are illustrated in the graph of FIG. 26 represented across the mass flow rates measured.

The present incompressible fluid pump provides options on arrangements for increasing the efficiency of a pump. Depending on the application for the pump the pump arrangements described herein can significantly increase efficiency where short term use is suitable. Alternatively, a significant increase in efficiency coupled with the convenience of a variable flow/pressure output is also possible with the pump described herein. Because of the efficiencies achieved and the generally high pump performance, the pump described herein could also be suitably used in a single stage for high pressure applications where multi-staged pumps would otherwise be employed.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, namely, to specify the presence of the stated features but not to preclude the presence or addition of further features in various embodiments of the invention.

It is to be understood that the aforegoing description refers merely to preferred embodiments of invention, and that variations and modifications will be possible thereto without departing from the spirit and scope of the invention, the ambit of which is to be determined from the following claims.

1. A centrifugal incompressible fluid pump comprising a casing with a pump inlet and a pump outlet, the casing housing an impeller powered to rotate by a drive system and having a fluid passage between an impeller fluid inlet and a fluid outlet located radially of the fluid inlet; and a recovery by-pass turbine system comprising a recovery by-pass turbine mounted to rotate with the impeller, wherein the recovery turbine system diverts a portion of fluid that has exited the impeller fluid outlet back into the impeller fluid intake, wherein the remaining portion of fluid exits the pump through the pump outlet.

2. The pump claimed in claim 1, wherein the recovery turbine system further includes a valve mechanism to vary the portion of fluid diverting to the recovery turbine.

3. The pump claimed in claim 2, wherein the valve mechanism is mounted circumferentially of and coaxially with the by-pass turbine.

4. The pump claimed in claim 2, wherein the valve mechanism is controlled by an electronic controller, wherein the controller responds to changes in output pressure in the fluid exiting the impeller fluid outlet.

5. The pump claimed in claim 2, wherein the valve mechanism comprises a stator assembly fixed to the casing and having a variable width opening controlled by outlet pressure in the flow path immediately before the stator assembly.

6. The pump claimed in claim 5, wherein the stator assembly comprises a stator inner piece and a stator outer piece configured to move reciprocally to open and close the width opening.

7. The pump claimed in claim 2, wherein the valve mechanism includes stator blades that direct fluid to corresponding runner blades of the by-pass turbine.

8. The pump claimed in claim 7, wherein the stator blades are provided on one of the stator inner piece or the stator outer piece of the stator assembly, with corresponding blade cavities being provided on the other of the stator inner piece or the stator outer piece.

9. The pump claimed in claim 1, wherein the by-pass turbine is a reaction turbine mounted onto an impeller shroud of the impeller.

10. The pump claimed in claim 1, wherein the by-pass turbine comprises a tubular casing having a diameter that decreases uniformly along its length from a flared maximum diameter where fluid enters the by-pass turbine, to a reduced internal diameter that meets a matching internal diameter of the impeller to which fluid is transferred.

11. The pump claimed in claim 1, further comprising a fluid turbine positioned adjacent the impeller fluid outlet that is driven by fluid exiting the impeller fluid outlet, wherein power harnessed by the fluid turbine is transferred by a drive output back into the drive system.

12. The pump claimed in claim 11, wherein the fluid turbine is positioned between the impeller fluid outlet and the recovery turbine system.

13. A centrifugal incompressible fluid pump comprising a casing that houses an impeller powered by a drive system and having a fluid passage between a fluid inlet and a fluid outlet located radially of the fluid inlet; and a fluid turbine positioned adjacent the impeller fluid outlet that is driven by fluid exiting the impeller fluid outlet, wherein power harnessed by the fluid turbine is transferred by a turbine drive back into the drive system; wherein the direction of fluid flowing through the impeller fluid passage and through the fluid turbine curves radially in a U -shape direction so that fluid exits the fluid turbine back towards the same direction from which fluid enters the impeller fluid intake.

14. The pump claimed in claim 13, wherein the impeller comprises impeller blades defining the fluid passage, wherein the fluid passage curves rearwardly and radially from a blade leading edge at the fluid inlet to the impeller fluid outlet through a curvature of between 90°-180°.

15. The pump claimed in claim 14, whereby as the fluid passage curves to the impeller fluid outlet, it also narrows in width thereby accelerating fluid flow.

16. The pump claimed in claim 13, wherein the fluid impeller passage completes part of a curve of the U-shape direction, and the fluid turbine completes the remaining part of the curve.

17. The pump claimed in claim 1, wherein the pump operates on a single external input drive.

18. The pump claimed in claim 11, wherein the fluid turbine is an impulse turbine.

19. The pump claimed in claim 13, wherein the pump operates on a single external input drive.

20. The pump claimed in claim 13, wherein the fluid turbine is an impulse turbine.
